(19) United States
(12) Patent Application Publication
(10) Pub. No.: US 2010/0027259 A1
(43) Pub. Date: Feb. 4, 2010

(54) FLUORESCENT TUBE REPLACEMENT HAVING LONGITUDINALLY ORIENTED LEDS

(75) Inventors: David L. Simon, Grosse Pointe Woods, MI (US); John Ivey, Farmington Hills, MI (US)

Correspondence Address: YOUNG BASILE, 3001 WEST BIG BEAVER ROAD, SUITE 624, TROY, MI, 48084, US

(73) Assignee: ALTAIR ENGINEERING, INC., Troy, MI (US)

(21) Appl. No.: 12/183,363

(22) Filed: Jul. 31, 2008

(51) Int. Cl. F21V 5/00; F21V 21/00; H01J 9/00

(52) U.S. Cl. 362/245; 362/244; 362/246; 445/23; 362/249.07

(57) ABSTRACT

An LED-based light for replacing a conventional fluorescent tube in a fixture is provided. The LED-based light includes an elongate light transmitting rod defining a bore and at least one LED positioned at one or both ends of the rod and oriented to produce light longitudinally into a portion of the rod radially outward of the bore. At least one connector is physically coupled to an end of the rod and electrically coupled to the at least one LED. The at least one connector is adapted for physical and electrical connection to the fixture. In operation, the directional light produced by the at least one LED is dispersed by way of reflection, refraction, and/or diffusion while traveling longitudinally through the rod to reduce the appearance of bright spots.

### TECHNICAL FIELD

The present invention relates to an LED-based light for replacing a conventional fluorescent tube in a fluorescent fixture.

### BACKGROUND

Light emitting diodes (LEDs) have many advantages over fluorescent lights. LEDs are more efficient, last longer, and are less sensitive to vibrations and low temperatures. To take advantage of the benefits of LEDs, lights in the shape of conventional fluorescent tubes have been constructed to include LEDs. Known fluorescent tube-shaped lights using LEDs are constrained by the directional light output of the LEDs, in contrast to the uniform non-directional light output of fluorescent tubes.

### BRIEF SUMMARY

Known lights including LEDs provide directional light output that may result in the appearance of bright spots on the light. Thus, known lights including LEDs may appear different from fluorescent lights, which are characterized by their uniform light distribution. An LED-based light according to the present invention can provide a more uniform light output than the some known lights including LEDs in order to more closely match the light distribution of a fluorescent light. In general, an LED-based light for replacing a conventional fluorescent tube in a fixture includes an elongate light transmitting rod defining a bore. At least one LED is positioned at one or both ends of the rod and oriented to produce light longitudinally into a portion of the rod radially outward of the bore. At least one connector is physically coupled to an end of the rod and electrically coupled to the at least one LED, and the at least one connector is adapted for physical and electrical connection to the fixture.

In another embodiment, an LED-based light for replacing a conventional fluorescent tube in a fixture is described. An elongate light transmitting rod defines a bore. Multiple LEDs are positioned at one or both ends of the rod and oriented to produce light longitudinally into a portion of the rod radially outward of the bore. A pair of bi-pin end caps are coupled to opposing ends of the rod, and at least one of the bi-pin end caps is in electrical communication with the multiple LEDs.

In yet another embodiment, a method of forming an LED-based light for replacing a conventional fluorescent light in a fixture includes providing an elongate light transmitting rod defining a bore, positioning at least one LED to produce light longitudinally into a portion of the rod radially outward of the bore, and attaching a pair of bi-pin end caps to opposing ends of the rod, with at least one of the end caps in electrical communication with the at least one LED.

### BRIEF DESCRIPTION OF THE DRAWINGS

The description herein makes reference to the accompanying drawings wherein like reference numerals refer to like parts throughout the several views, and wherein:

FIG. 1 is a perspective view of an LED-based light according to the present invention;

FIG. 2 is a perspective view of the rod of the LED-based light of FIG. 1;

FIG. 3 is a perspective view of an LED-based light including a bored rod having an uneven light refracting texture on its inner circumference;

FIG. 4 is a perspective view of an LED-based light including a bored rod and a reflector positioned in the bore;

FIG. 5 is a perspective view of an LED-based light including a bored rod and a light diffusing material in the bore; and

FIG. 6 is a perspective view of an LED-based light including a bored rod having a textured outer surface.

FIG. 7 is a perspective view of an LED-based light including a bored rod having a textured outer surface in the shape of the word “LOGO”.

### DETAILED DESCRIPTION OF EMBODIMENTS OF THE INVENTION

Embodiments of an LED-based light for replacing a conventional fluorescent tube in a fixture are illustrated in FIGS. 1-7. FIG. 1 illustrates an LED-based light 10 for use in a fixture 12 designed to accept conventional fluorescent tubes. The light 10 includes an elongate light transmitting rod 14, bi-pin end caps 16, and LEDs 18 positioned between the rod 14 and one of the end caps 16.

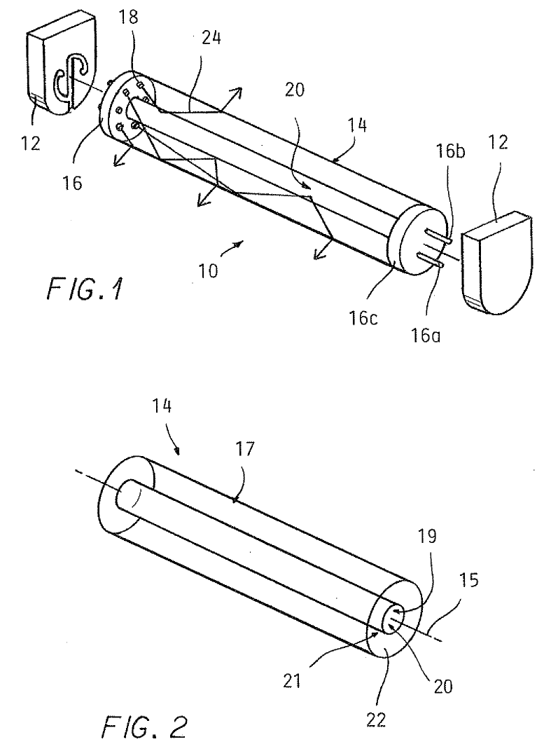

The rod 14 as shown in FIG. 2 defines a longitudinal axis 15, an outer surface 17, an inner surface 19, and two end surfaces 21 extending radially between the outer surface 17 and inner surface 19. A solid body portion 22 is the mass between the outer surface 17 and inner surface 19. While not illustrated to scale, the rod 14 can be approximately 48″ long with a 0.625″, 1.0″, or 1.5″ diameter for engagement with the fluorescent fixture 12. The rod 12 can be made from polycarbonate, acrylic, glass or another light transmitting material. That is, the rod 14 can be transparent or translucent. For example, a translucent rod 14 can be made from a composite, such as polycarbonate with particles of a light refracting material interspersed in the polycarbonate. While the illustrated rod 14 is cylindrical, the rod 14 can alternatively have a square, triangular, polygonal, or other cross sectional shape. Similarly, while the illustrated rod 14 is linear, the rod 14 can have an alternative shape, e.g., a U-shape. Also, each light 10 can include multiple rods 14 arranged end-to-end, in which case LEDs 18 can be positioned between the rods 14.

As shown in FIG. 2, the rod 14 further defines a bore 20. The bore 20 as illustrated is cylindrical and coaxial with the rod 14. Alternatively, the bore 20 can have a different cross sectional shape, such as a square, triangle, polygon, or other shape. The cross-sectional shape of the bore 14 can vary over the length of the rod 14. For example, the diameter of the bore 20 can be small adjacent the LEDs 18 and grow larger moving down the length of the rod 14. Moreover, the bore 20 can extend only a portion of the length of the rod 14, and the bore 20 can be off center, i.e., not aligned with the longitudinal axis 15 of the rod 14.

Referring back to FIG. 1, the LED-based light 10 includes one of the bi-pin end caps 16 at each of its ends 21 for physically and electrically connecting the light 10 to the fixture 12. The bi-pin end caps 16 can contain elements for physical and electrical connection to the LEDs 18. For example, the end caps 16 can contain a reflector, a heat sink, and/or an electric circuit including a circuit board. Alternate devices for physically and electrically connecting the LEDs 18 can be used, such as a metal core circuit board or physically attaching the LEDs 18 directly to the rod 14 and wiring the LEDs 18 together. Each end cap 16 includes two pins, 16a and 16b, for a total of four pins. However, only two of the four pins must provide an electrical connection between the fixture 12 and the LEDs 18; the other two pins can be “dummy pins”. Also, while the end caps 16 are shown as including cup-shaped bodies 16c engaged with the rod 14 by sliding the end caps 16 over the ends 21 of the rod 14, end caps can have differently shaped bodies 16c. For example, the end caps 16 can include projections press-fit into the bore 20 for connection to the rod 14, or the ends caps 16 can be screwed to the rod 14. Additionally, end caps having other types of connectors, e.g., single-pin connectors, can be used depending on the design of the fixture 12.

The LEDs 18 as illustrated in FIG. 1 are positioned at one of the ends 21 of the rod 14 and oriented to face parallel to its longitudinal axis 15. As a result of the position of the LEDs 18, the LEDs 18 can produce light that travels longitudinally into the solid body portion 22 of the rod 14 through one of its ends 21. However, the LEDs 18 can be oriented at various angles relative to the longitudinal axis 15 while still producing light that travels longitudinally into the rod 14. The angle at which LEDs 18 can be oriented relative to the axis 15 can be a function of the viewing angle of the LEDs 18, the longitudinal distance light is desired to travel, and the light directing properties of the rod 14. Additionally, LEDs 18 can be positioned at both ends of the rod 14 instead of just one end as illustrated in FIG. 1.

The number of LEDs 18 can be a function of the desired power of the light 10 and the power of the LEDs 18, and the LEDs 18 can be evenly spaced in a circular pattern around the bore 20 as shown in FIG. 1. However, the LEDs 18 can be alternatively be spaced at other intervals, such as clustered on a side of the light 10 oriented facing a space to be illuminated. LEDs 18 can additionally be positioned at various locations along the length of the rod 12. For example, LEDs 18 can be attached to opposing ends of the rod 14 for producing light that enters the rod 14 from both ends. If the light 10 includes multiple rods 14, LEDs 18 can be positioned at the rod 14 junctions.

The LEDs 18 can be surface-mount devices of a type available from Nichia, though other types of LEDs can alternatively be used. For example, although surface-mounted LEDs 18 are shown, one or more organic LEDs can be used in place of or in addition thereto. The LEDs 18 can be attached to a printed circuit board in one of the end caps 16 as described above, and the LEDs 18 included in the LED light assembly 14 emit white light. However, LEDs that emit blue light, ultra-violet light or other wavelengths of light can be used in place of white light emitting LEDs 18.

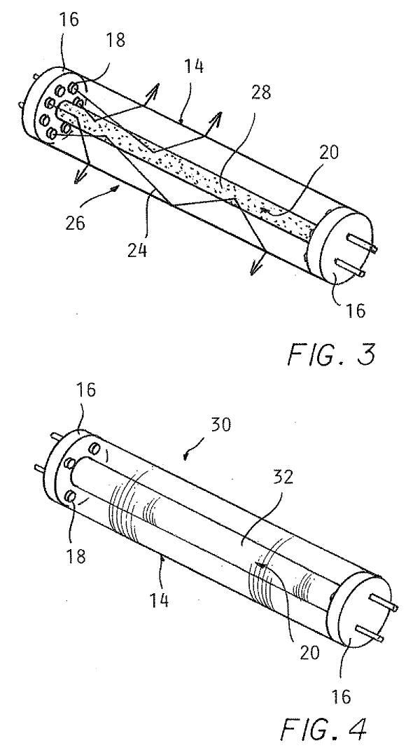

Due to the shape of the bored rod 14 and the position and orientation of the LEDs 18, light produced by the LEDs 18 enters the solid body portion 22 of the rod 14 as illustrated by light rays 24 in FIG. 1. The light rays shown in FIG. 1, as well as any light rays 24 included in FIGS. 3-7, are for illustrative purposes only and are not intended to accurately portray the actual dispersion of light from the LEDs. Each LED 18 produces light in a generally conical pattern; not all light travels parallel to the longitudinal axis 15 of the rod 14. As a result, after the light enters the rod 14, a portion of the light encounters the outer surface 17 at an angle greater than an angle of incidence required for refraction and is reflected back toward the surface 19. Another portion of light refracts through the outer surface 17 shortly after entering the rod. Similarly, a portion of light is reflected off the inner surface 19 after entering the rod 14. Such light can exit through the outer surface 17 if the light encounters the surface 17 at an angle smaller than the angle of incidence, or the light can be reflected back toward the inner surface 19. As a result of light reflecting between the surfaces 17 and 19, different portions of light travel different distances through the rod 14 before exiting the rod. In other words, light is emitted from the rod 14 at various distances along its longitudinal axis 15. Thus, the light 10 can provide a distribution of light adequately uniform to simulate a fluorescent tube.

FIG. 3 illustrates a light 26 similar to the light 10 of FIG. 1, except the inner surface 19 of the rod 14 includes an uneven light reflecting texture 28. The texture 28 alters the angle of incidence of rays 24 relative to the inner surface 19. As a result, the light reflecting texture 28 can increase the efficiency of the light 26 by reducing the amount of light that refracts into the bore 20. The texture 28 consists of light directing structures such as ridges, dots, bumps, dimples and/or other uneven surfaces. The light directing structures can vary in density across the length of the rod 14, with the structures less dense adjacent the LEDs 18 and more dense longitudinally and/or circumferentially spaced from the LEDs 18. The varying density of the light directing structures allows a lower percentage of light to be dispersed where the amount of light is high (i.e., adjacent the LEDs 18) and a higher percentage of light to be dispersed where the amount of light is low (i.e., longitudinally spaced from the LEDs 14). Greater light dispersion increases the amount of light exiting the rod 14, thereby achieving a substantially uniform distribution of light along the entire length of the rod 14. Similarly, the texture 28 can include surfaces angled slightly relative to the longitudinal axis 15 adjacent the LEDs 18 and surfaces angled greater relative to the longitudinal axis 15 spaced from the LEDs 18. The placement of the structures making up the light directing texture 28 can be determined by software, such as the software disclosed in Michael Zollers, “Integrated Optimization Capabilities Provide a Robust Tool for LED Backlight Design,” LEDs Magazine (October 2006), pp. 27-29, which is hereby incorporated by reference, though the placement can alternatively be determined by hand-calculation or experimentation.

FIG. 4 illustrates a light 30 similar to the light 10, except the light 30 includes a reflector 32 positioned in the bore 20. The reflector 32 can be a mirror made of glass or plastic with a metallic coating on its backside and can include a diffusing surface (not shown) if desired. As described above, the LEDs 18 are spaced around the bore 20 and emit light longitudinally into the rod 14. A portion of the light contacts the inner surface 19, and some of this light refracts through the surface 19 into the bore 20. The light entering the bore 20 can be reflected by the reflector 20 back into the rod 14, where it can then pass through the outer surface 17 and illuminate a space to be illuminated. As a result, the reflector 32 increases the efficiency of the light 30.

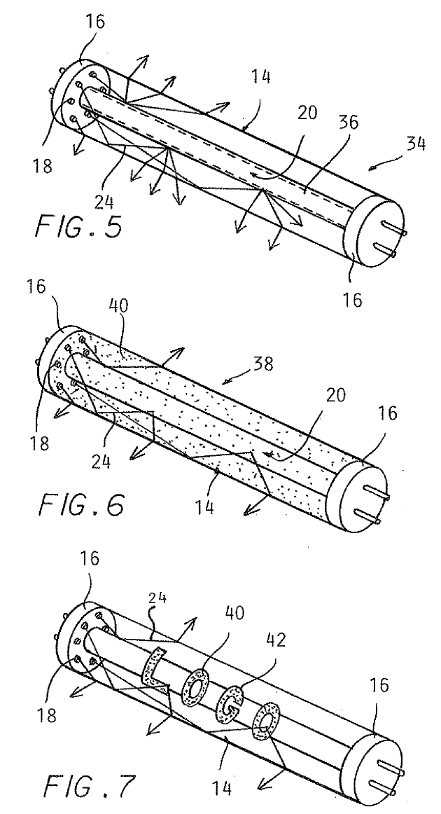

FIG. 5 illustrates a light 34 similar to the light 10, except the bore 20 of the light 34 includes a light diffusing material 36. The light diffusing material 36 can be, for example, silicone, epoxy, or clear polyurethane. The material 36 diffuses light entering the bore 20. The diffused light travels through the bore 20 until it contacts the inner surface 19 at an angle such that the light refracts into back the rod 14. By dispersing light entering the bore 20, the light diffusing material 36 can aid in more uniformly distributing light from the rod 14. Further, the light diffusing material 36 may have a higher coefficient of thermal conductivity than the rod 14, such as when silicone is used as the material 36. As a result, the material 36 can act as a heat sink by dissipating heat produced by the LEDs 18.

FIG. 6 illustrates a light 38 similar to the light 10, except the outer surface 17 includes an uneven light reflecting texture 40 similar to the previously described texture 28. The texture 40 can vary over the length of the rod 14, for example by varying the density or geometry of the structures making up the texture 40 as described above in reference to the texture 28. Additionally, the texture 40 can be shaped to form an alphanumeric character, a picture, or another shape. For example, as shown in FIG. 7, the word “LOGO” 42 is formed from the texture 40. By forming light reflecting texture 40 in the shape of alphanumeric characters and/or pictures, a greater amount of light exits the rod 14 through the “LOGO” 42 than other areas of the surface 17. Thus, the alphanumeric characters and/or pictures appear more brightly lit than the remainder of the outer surface 17 of the rod 14. The portion of the outer surface 17 not including the word “LOGO” 42 can also be textured for controlling the passage of light through the remainder of the outer surface 17, though with a different texture than the texture 40 forming “LOGO” 42.

The lights shown in each of FIGS. 1 and 3-7 can include additional features not illustrated. For example, a diffusing layer can be wrapped around the exterior of the rod 14 or positioned to line the bore 20.

The above-described embodiments have been described in order to allow easy understanding of the invention and do not limit the invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. An LED-based light for replacing a conventional fluorescent tube in a fixture, the LED-based light comprising:
an elongate light transmitting rod defining a bore;
at least one LED positioned at one or both ends of the rod and oriented to produce light longitudinally into a portion of the rod radially outward of the bore; and
at least one connector physically coupled to an end of the rod and electrically coupled to the at least one LED, the at least one connector adapted for physical and electrical connection to the fixture.

2. The LED-based light of claim 1, wherein the rod includes an uneven light refracting texture.

3. The LED-based light of claim 2, wherein the texture varies over a length of the bore.

4. The LED-based light of claim 2, wherein the texture is less dense adjacent the at least one LED and more dense further away from the at least one LED.

5. The LED-based light of claim 2, wherein the light refracting texture is shaped in the form of one of an alphanumeric character and a picture.

6. The LED-based light of claim 1, wherein the bore encloses a reflector.

7. The LED-based light of claim 1, wherein the bore encloses a light diffusing material.

8. The LED-based light of claim 7, wherein the light diffusing material includes silicone.

9. An LED-based light for replacing a conventional fluorescent tube in a fixture, the LED-based light comprising:
an elongate light transmitting rod defining a bore;
multiple LEDs positioned at one or both ends of the rod and oriented to produce light longitudinally into a portion of the rod radially outward of the bore; and
a pair of bi-pin end caps coupled to opposing ends of the rod, at least one of the bi-pin end caps in electrical communication with the multiple LEDs.

10. The LED-based light of claim 9, wherein the rod includes an uneven light refracting texture.

11. The LED-based light of claim 10, wherein the texture varies over a length of the bore.

12. The LED-based light of claim 10, wherein the texture is less dense adjacent the LEDs and more dense further away from the LEDs.

13. The LED-based light of claim 10, wherein the light refracting texture is shaped in the form of one of an alphanumeric character and a picture.

14. The LED-based light of claim 9, wherein the bore encloses a reflector.

15. The LED-based light of claim 9, wherein the bore encloses a light diffusing material.

16. The LED-based light of claim 15, wherein the light diffusing material includes silicone.

17. A method of forming an LED-based light for replacing a conventional fluorescent tube in a fixture, the method comprising:
providing an elongate light transmitting rod defining a bore;
positioning at least one LED to produce light longitudinally into a portion of the rod radially outward of the bore; and
attaching a pair of bi-pin end caps to opposing ends of the rod, with at least one of the end caps in electrical communication with the at least one LED.

18. The method of claim 17, further comprising forming an uneven light reflecting texture on the rod.

19. The method of claim 17, further comprising placing a reflector in the bore.

20. The method of claim 17, further filling the bore with silicone.
